(19) United States
(12) Patent Application Publication
(10) Pub. No.: US 2004/0164122 A1
(43) Pub. Date: Aug. 26, 2004

(54) Nail setting tool

(76) Inventor: Richard Borkowski, Elizabeth, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/374,158

(22) Filed: Feb. 25, 2003

(51) Int. Cl. B25C 7/00

(52) U.S. Cl. 227/147

(57) ABSTRACT

A nail setting tool has a body with an internal drive shaft and rubber end caps. A nail may be placed in the driving end of the body, and the nail is held in place by the gripping action of the rubber end cap. The internal drive shaft is held in place inside the body with a post and slot arrangement. A user may thus align, drive and counter sink a nail into a workpiece in one operation, without marring the workpiece or losing the nail. The nail setting tool also eliminates pinch points for added safety.

### BACKGROUND OF THE INVENTION

1. Field of the Invention

This device relates to hand tools for nailing operations and, more particularly, to nail setting tools.

2. Description of Related Art

Anyone who has ever pounded a nail knows what can go wrong, especially in detailed woodworking. Smashed fingers and bent nails are common problems. Another problem is marring of the workpiece, for example detail molding, which for obvious reasons is undesirable.

The prior art has attempted to address these problems with various nail set designs. For example, in FIGS. 1 and 2 herein, a commercially available nail set is shown. This nail set, however, is to be used only after the nail is initially driven into the workpiece by hand. Referring to FIG. 1, the nail set A is placed over the head of the nail B, after the nail has been initially driven into the workpiece C. A drive shaft D is shown position above the head of the nail B.

Referring now to FIG. 2, a hammer E is used to impact the shaft D, driving the nail B into the workpiece C, in a counter-sinking fashion. The nail set has a spring F which returns the drive shaft D to an upright position, after each blow of the hammer E.

This commercially available nail set has drawbacks in that the nail set provides no protection from marring of the workpiece, and the nail set provides no capability to hold the nail steady in the nail set. It is only designed to finish the nail after initial pounding into the workpiece by hand.

Others have attempted to provide nail sets wherein the nail is pounded into the workpiece and finished, in one operation. For example, U.S. Pat. No. 2,866,974 describes a nailing implement having a resilient insert, with a brake shoe that keeps the nail from falling out the end of the nailing implement. A second brake shoe is required on the driving member so that the driving member will not fall out the upper end of the nailing implement.

U.S. Pat. No. 1,127,838 describes a tack driver with a magnetized projection that holds the nail in place in the driving end of the tack driver. However, the knurled head on the tack driver represents an unsafe pinch point.

U.S. Pat. No. 1,776,646 describes a nail driver and set which uses a spring washer to provide resistance for preventing the driving shaft from falling out the upper end of the nail set. This nail set has no capability to hold the nail in place prior to driving.

U.S. Pat. No. 4,179,058 discloses a soffit nail set having a coating on the driving end of the nail set, but no capability for retaining the nail in the driving end of the nail set is disclosed. Furthermore, the exterior slot and post arrangement on this soffit nail set is unsafe, because it presents an external pinching point.

U.S. Pat. No. 1,980,583 discloses a nail set which is largely made of rubber. However, a steel bushing is vulcanized in the driving end of the rubber, where the nail is placed. As evident from the short length of bushing 8 this nail set is not designed to retain the nail before driving, but rather only to finish it after initial driving of the nail by hand. Nor is there any apparatus for retaining the drive shaft in the upper end of the nail set, so that accidental separation of those two parts appears likely.

Other nail sets are disclosed in U.S. Pat. Nos. 952,571, 3,060,440, 3,342,228 and 2,199,833.

It is an object of the present invention to overcome the shortcomings of the above prior art and to provide a simple, inexpensive nail set which facilitates holding, positioning, driving and counter sinking of nails in one operation, avoiding all possible pinch points on the nail set, and eliminating the possibility of marring the workpiece by the driving end of the nail set. It is a further object to provide a capability to reliably and cheaply retain the nail in the driving end of the nail set prior to the driving operation.

### SUMMARY OF THE INVENTION

A nail setting tool according to the invention, has a body with a throughbore and a drive shaft positioned in the throughbore. The drive shaft is reciprocally movable in a longitudinal manner with respect to the throughbore. At least one stop device limits the range of reciprocal movement of the drive shaft. An elastomeric nail retaining and mar prevention device is located on a driving end of the body. The elastomeric device has a gripping bore, and elastomeric material which defines the gripping bore is configured to grip or retain a nail when inserted therein. This prevents accidental dislodgment of the nail from the setting tool.

The resilient nail retaining and mar prevention device may comprise a rubber end cap, which is fitted onto the driving end of the body of the setting tool. In a preferred embodiment, the gripping bore may have a diameter which is smaller than the diameter of the throughbore in the body. The drive shaft may include a slot which receives an internally positioned post to limit movement of the drive shaft in a longitudinal manner. The drive shaft may be sufficiently long so that, when a striking end of the shaft is roughly flush with the striking end of the body, a driving end of the shaft protrudes from the gripping bore, so as to facilitate counter sinking a nail.

The invention also includes a method of securing a fastener and workpiece, using a striking implement and a setting tool. First, a fastener is inserted in a driving end of a bore located in the setting tool. The fastener is then retained in the bore with an elastomeric retention device, which device is located at the driving end of the bore. Next, the elastomeric retention device is positioned in contact with a workpiece, and the striking implement is impacted with the setting tool. This drives the fastener longitudinally through the elastomeric retention device into the workpiece.

The method may include the further step of counter sinking the fastener into the workpiece by impacting the striking implement with the setting tool. In a preferred embodiment of the method, a fastener is retained in the elastomeric retention device by a gripping action of elastomeric material around a periphery of the fastener. The method may also include the step of visually indicating to a user when the fastener is fully counter sunk into the workpiece.

Other details and advantages of the invention will be apparent from the following drawing and description.

### BRIEF DESCRIPTION OF THE DRAWINGS

FIGS. 1 and 2 show a prior art nail set device;

FIG. 3 is a front elevation view of a nail set, with a nail charged in the driving end, according to the preferred embodiment of the invention;

FIG. 4 is a front elevation view showing the nail set and the nail, after the driving operation;

FIG. 5 is a longitudinal cross sectional view of the nail set and nail of FIG. 3;

FIG. 6 is an exploded view of the nail set of FIG. 3, excluding the nail;

FIG. 7 is an isolation view of the nail set of FIG. 4;

FIG. 8 is an elevation view of a driving shaft according to the preferred embodiment of the invention; and

FIG. 9 is a sectional view of a nail set body according to the preferred embodiment of the invention.

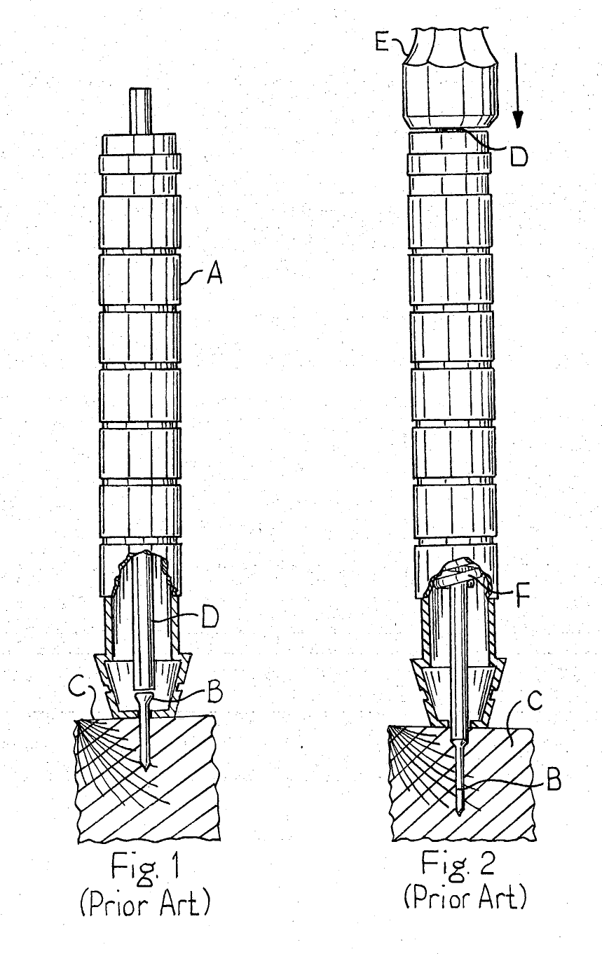

### DESCRIPTION OF THE PREFERRED EMBODIMENTS

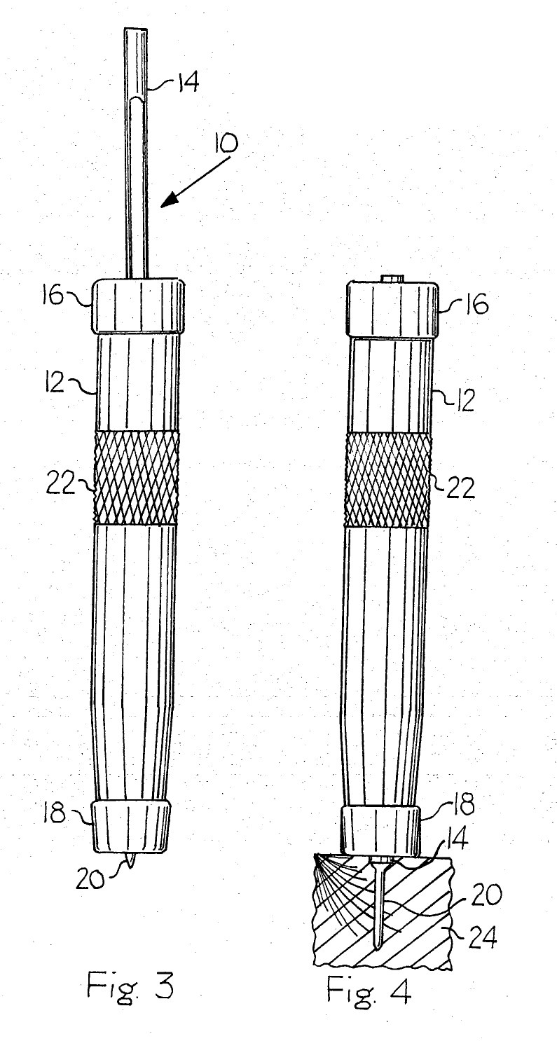

Referring to FIGS. 3-5, a nail set 10 has a body 12 and a drive shaft 14. The body 12 carries an upper end cap 16 and a lower end cap 18, each cap made from a resilient, soft rubbery elastomer. The tip of a nail 20 is shown protruding from end cap 18 in FIG. 3. The body 12 is preferably made from steel or other suitable like substance, and it may be provided with knurled section 22. The nail set 10 is utilized to drive the nail 20 into a workpiece 24, as shown in FIG. 4 and as will be described in further detail below.

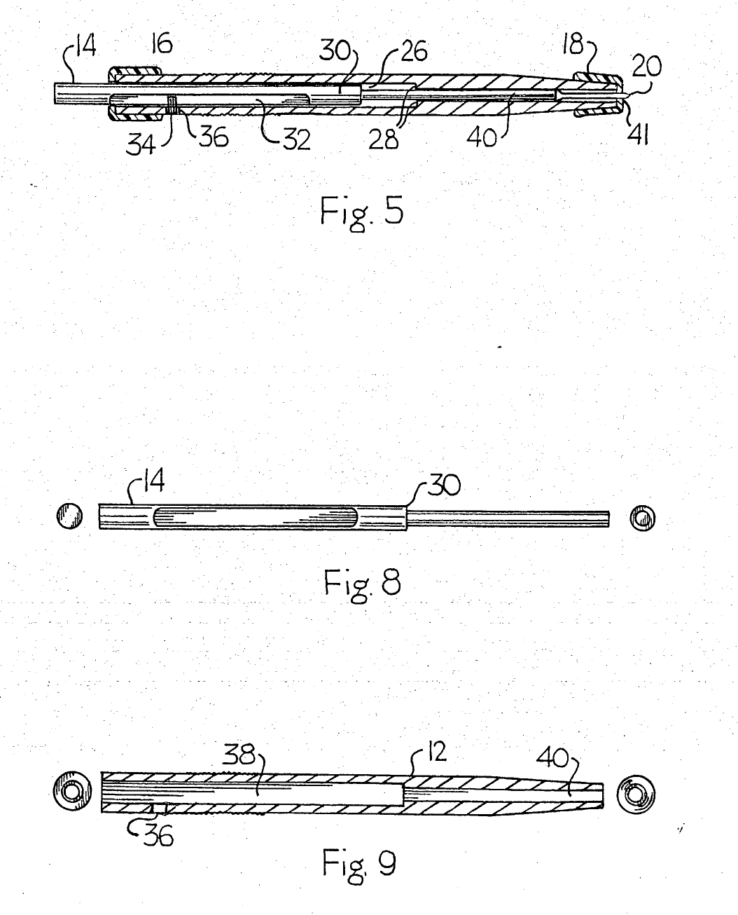

Referring to FIG. 5, drive shaft 14 is located within body 12 and throughbore 26. Throughbore 26 includes a shoulder 28 on which enlarged portion 30 of drive shaft 14 may bear. The drive shaft 14 is thus limited in how far it may extend outward, beyond end cap 18. This protrusion of drive shaft 14 facilitates counter-sinking of the nail into the workpiece, as will be described in further detail below. A typical protrusion of shaft 14 is illustrated in FIG. 4.

Enlarged portion 30 of drive shaft 14 contains a slot 32, which is milled into the enlarged portion 30. Slot 32 receives a post 34, which post rides inside slot 32 as the drive shaft 14 is reciprocated longitudinally. Post 34 may be force fitted or welded inside bore 36 of body 12.

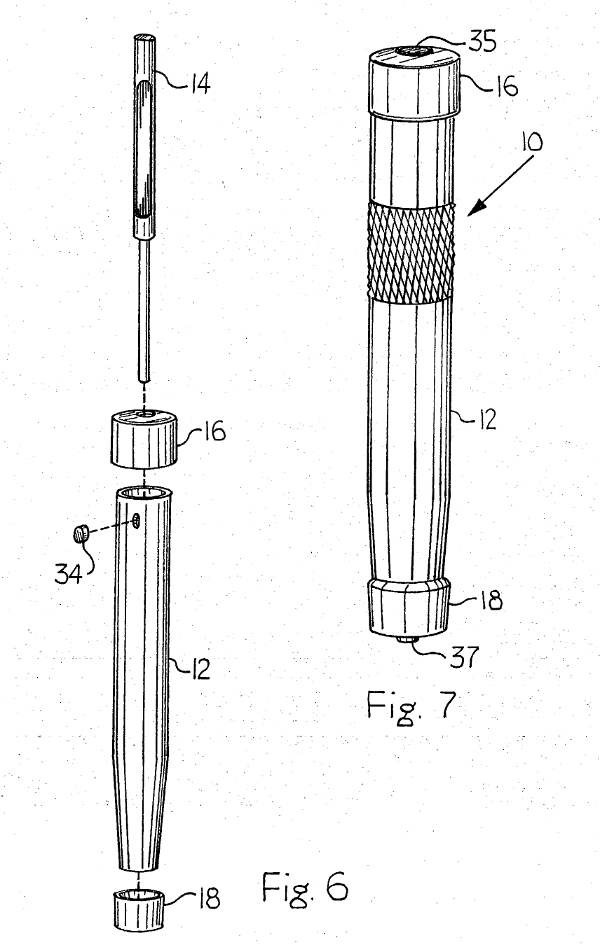

The nail set 10 according to the preferred embodiment of the invention is comprised of only five parts, as evident from FIG. 6. FIG. 7 shows a perspective view of the nail set 10, according to the preferred embodiment of the invention, when assembled. As shown, the top 35 of drive shaft 14 is almost flush with end cap 16, when the lower end 37 of shaft 14 protrudes from lower end cap 18. This provides a visual indicator to the user to stop pounding.

As shown in FIG. 8, the drive shaft 14 has two diameters, with the driving end of the drive shaft 14 having a smaller diameter than the enlarged portion 30 of the drive shaft. Likewise, as shown in FIG. 9, the throughbore 26 has a first large diameter portion 38 and a second small diameter portion 40.

In use, a nail 20 is first inserted in the opening 41 of rubber end cap 18, as shown in FIG. 5. This causes drive shaft 14 to travel upward to provide space for housing the nail 20 inside the small diameter portion 40 of the throughbore 26. The action of the rubber end cap 18, whose opening 41 is preferably of a smaller diameter than the small diameter portion 40, grips the nail 20 to hold it in place. This prevents accidental falling of the nail from the nail set tool, when the nail set tool is being gripped and moved about by the user.

The nail set 10 with the nail 20 in place, is then located at the spot where the user intends to drive the nail into the workpiece 24. Once the nail is properly located, the user then strikes a hammer on the upper end of drive shaft 14, while the user grips the nail set at the body portion 12 adjacent knurls 22. As the hammer strikes the drive shaft 14, the drive shaft transfers that blow to the head of nail 20, and in one operation, the nail is driven into the workpiece and also countersunk by the action of the protruding end 37 of the drive shaft, as shown in FIG. 4.

The range of travel for the drive shaft 14 is limited by the shoulder 28 and throughbore 26, which acts as a stop against the enlarged portion 30 of the drive shaft 14. Likewise, post 34, traveling within slot 32, prevents the complete withdrawal of the drive shaft 14 from the throughbore 26 of the nail set 10.

The end cap 18 prevents marring of the workpiece by the hammering action required to drive the nail 20. The end cap 18 is also uniquely designed to provide a grip on the nail 20 so that it does not fall out of the driving end of the nail set 10 before the hammering operation. This elegant combination of mar prevention and nail gripping is heretofore undisclosed in the prior art. With the rubber end cap 18, according to the preferred embodiment of the invention, it is no longer necessary to provide additional apparatus at the driving end of the nail set to retain the nail, nor is it necessary to magnetize the drive shaft 14. Thus, the present invention provides additional advantages, but it is cheaper, and less complicated to manufacture than its predecessors.

The post 34 and groove 32 internal arrangement of the present invention provides a positive stop to avoid accidental back out of the drive shaft 14 from the body 12 of the nail set 10, and this is done in a way so that there are no pinch points on the exterior of the nail set. This post/groove arrangement is also very durable and not subject to wear.

As an alternative to the post 34 shown herein, the sidebore 36 could be drilled and tapped, and the post then replaced with a set screw. This facilitates replacement of the drive shaft 14, in the unlikely event that becomes necessary.

The body 12 and drive shaft 14 are preferably manufactured from tool steel. The body 12 may be forged, and it is preferred that the drive shaft 14 be made from hardened steel. Upper end cap 16 is optional, but it does help dissipate the energy of the hammerhead and further prevents marring. It is anticipated that different size nail set tools 10 may be required for different size finish nails.

Instead of the post and slot arrangement, a flat could be milled on the enlarged portion 30 of the drive shaft 14, and the post 34 would then ride on that flat. Finally, it may be possible to construct the nail set body 12 completely (or at least in part at the driving end) from a harder elastomer, thus eliminating the end caps. Care must be taken in that case, however, to ensure the rubber at the driving end of the nail set is not so hard as to increase the risk of marring.

Other modifications and alternative embodiments of the invention will be apparent to those skilled in the art, upon reading the instant specification. It is intended that the invention not be limited to the preferred embodiments described herein but rather that the invention be limited only by the appended claims.

I claim:

1. A nail setting tool, comprising:
a body having a throughbore;
a drive shaft positioned in the throughbore, wherein the drive shaft is reciprocally movable in a longitudinal manner with respect to the throughbore;
at least one stop device for limiting the range of reciprocal movement of the drive shaft; and
an elastomeric nail retaining and mar prevention device located on a driving end of the body, said elastomeric device having a gripping bore, wherein elastomeric material which defines said gripping bore is configured to grip a nail when inserted therein, so as to prevent accidental dislodgment of the nail.

2. The nail setting tool of claim 1, wherein the stop device comprises a slot on the drive shaft and a post which travels inside the slot as the shaft is reciprocated.

3. The nail setting tool of claim 2, wherein the post is fixedly located in a sidebore positioned in a wall of said body.

4. The nail setting tool of claim 1 wherein the resilient nail retaining and mar prevention device comprises a rubber end cap, which is fitted onto the driving end of the body.

5. The nail setting tool of claim 4 wherein the rubber end cap includes said gripping bore, and the gripping bore has a diameter which is smaller than the diameter of the throughbore in said body.

6. The nail setting tool of claim 1, wherein the throughbore in said body has a first large diameter section and a second small diameter section with a shoulder separating said sections, said shoulder limiting the forward movement of said drive shaft.

7. The nail setting tool of claim 1 further including two rubber end caps, one on each end of said body.

8. The nail setting tool of claim 1, further including a knurled section on the outside of said body.

9. The nail setting tool of claim 2 wherein the post is a removable set screw.

10. The nail setting tool of claim 6, wherein the drive shaft has a first large diameter portion and a second small diameter portion, the small diameter portion contacting a nail when inserted in the driving end of said throughbore, and the large diameter portion providing a surface for striking by a hammer.

11. The nail setting tool of claim 1, wherein the drive shaft is of sufficient length so that when a striking end of said shaft is approximately flush with the striking end of said body, a driving end of said shaft protrudes from said gripping bore, so as to facilitate counter sinking a nail.

12. A nail setting tool, comprising:
a body having a striking end and a driving end with a throughbore in said body, said throughbore having a small diameter section and a large diameter section with a shoulder separating said sections;
a drive shaft positioned in said throughbore and reciprocally movable therein, said drive shaft having a striking end and a driving end, said drive shaft having a large diameter portion and a small diameter portion, said large diameter portion adapted to bear against said shoulder, with a slot in the large diameter portion;
a post radially extending into said throughbore and received in said slot to limit the range of reciprocal movement of said shaft;
an elastomeric nail retaining and mar prevention device located on a driving end of the body, said elastomeric device having a gripping bore, wherein elastomeric material which defines said gripping bore is configured to grip a nail when inserted therein, so as to prevent accidental dislodgment of the nail; the gripping bore having a smaller diameter than said throughbore; and
wherein the drive shaft has a length such that after a nail driving operation, its striking end is approximately flush with the striking end of the body and its driving end protrudes from the gripping bore to facilitate counter sinking a nail.

13. The nail setting tool of claim 12, wherein the elastomeric nail retaining and mar prevention device is a rubber end cap.

14. The nail setting tool of claim 13 further including a second rubber end cap opposite the elastomeric nail retaining and mar prevention device.

15. A method of securing a fastener in a workpiece using a striking implement and a setting tool comprising the steps of:
1) inserting the fastener in a driving end of a bore located in the setting tool;
2) retaining the fastener in the bore with an elastomeric retention device, which device is located at the driving end of said bore;
3) positioning the elastomeric retention device in contact with a workpiece; and
4) impacting the striking implement with the setting tool to drive the fastener longitudinally through the elastomeric retention device into the workpiece.

16. The method of claim 15 including the further step of counter sinking the fastener into the workpiece by impacting the striking implement with the setting tool.

17. The method of claim 15, wherein the fastener is retained in the elastomeric retention device by a gripping action of elastomeric material around a periphery of the fastener.

18. The method of claim 16 including the further step of visually indicating to a user when the fastener is fully counter sunk into the workpiece.

19. The method of claim 15, wherein the striking implement is a hammer and the fastener is a nail.

20. The method of claim 15, wherein the elastomeric device is a rubber end cap having a gripping bore therein, the gripping bore having a diameter which is smaller than the diameter of the bore in the setting tool.
